(19) United States
(12) Patent Application Publication
(10) Pub. No.: US 2002/0161917 A1
(43) Pub. Date: Oct. 31, 2002

(54) Methods and systems for dynamic routing of data in a network

(76) Inventors: Aaron M. Shapiro, Atlanta, GA (US); Theodore John Roberts JR., Marietta, GA (US)

Correspondence Address: FINNEGAN, HENDERSON, FARABOW, GARRETT &, DUNNER LLP, 1300 I STREET, NW, WASHINGTON, DC, 20005, US

(21) Appl. No.: 09/845,419

(22) Filed: Apr. 30, 2001

(51) Int. Cl. G06F 15/16; G06F 15/173

(52) U.S. Cl. 709/238; 709/219

(57) ABSTRACT

Methods, systems, and articles of manufacture consistent with the present invention provide the ability to dynamically route data within a network. The data is received, along with an associated destination list, at a transmitting node in the network. The node identifies a destination for the data from the destination list. The node then references a dynamic routing table for routing information for the destination. Next, the node determines an efficient method of transmitting the data based on the routing information, and transmits the data to a neighbor node based on the determination of the method.

### FIELD OF THE INVENTION

This invention relates to systems for dynamically routing data through a network of nodes and, more particularly, to methods and systems for dynamically routing data through a network of nodes containing dynamic routing tables.

### BACKGROUND OF THE INVENTION

Over the last century, the apparent size of the earth has been reduced by the rapid increase in speeds of travel and communication. As we have moved from steam ship to diesel ships to propeller aircraft to jet aircraft, the apparent distances between people across the planet have shrunk. This reduction in travel time has led to increases in mobility throughout the world. Along with the increase in the mobility of people, there has been a concomitant increase in the speed at which people can communicate across distances. Postal communication gave way to telephonic communication that has yielded to computerized communication over the last one hundred years. Given the rise in computerized communications, people are searching for more efficient ways to utilize the limited bandwidth across distributed networks and increase the efficiency of data transfer.

The Internet is one example of a system to interconnect a plurality of nodes across a network. Within such a hierarchical system, Internet communications typically utilize a static routing table to route data from an origination node to a destination node. Generally, entries for a destination address will not be found in the routing table of an originating node, so data will be routed to a default node further up the Internet hierarchy, in hopes that at some point the data will arrive at its destination location. The data tends to be routed up the hierarchy, across the Internet, then down the hierarchy.

This Internet routing is commonly performed by an Internet routing mechanism. Typically, the routing mechanism consults a static routing table in each node to determine where to transfer a packet of data. Because the Internet is designed to be more of a hierarchical network than a peer-to-peer network, the static routing table rarely contains a destination address. In addition, the static routing table is rarely updated after the initial startup of the node.

The Internet also contains a limited form of dynamic routing. Conventional dynamic routing on the Internet is where nodes, designated as routers, communicate with each other using a routing protocol, or routing daemon, to exchange routing information. In the standard RIP routing protocol, a router requests and responds to requests for routing information to and from all points with which it is connected. Each router returns a listing of known interfaces and hop counts. Hop counts represent the number of nodes that must be traversed to reach the interface.

The RIP routing protocol will then update the route tables with the new interfaces and hop counts; however, the RIP system has problems stabilizing after the loss of a link and can often result in the generation of routing loops. In addition, no qualitative data is returned about the quality or speed of a link; only the number of hops. While a single hop may look good to a router, the single hop may be slow and a two hop link might be preferred. The RIP system cannot analyze this situation properly.

While other Internet routing protocols exist, none are known to take into account the quality or speed of a link. In addition, traditional Internet routing is inefficient for broadcasting of data because of the hierarchical nature of the Internet. The Internet routing processes do not provide an efficient peer-to-to peer routing system.

Accordingly, there is a need for delivering content across a network of nodes using a dynamically updating routing table. There is also a need for dynamic routing of data that takes into account the quality or speed of a link. There is also a need for dynamic routing of data that is oriented toward a peer-to-peer system.

### SUMMARY OF THE INVENTION

Methods, systems, and articles of manufacture consistent with the present invention provide the ability to dynamically route data within a network. The data is received, along with an associated destination list, at a transmitting node in the network. The node identifies a destination for the data from the destination list. The node then references a dynamic routing table for routing information to the destination. Next, the node determines an efficient method of transmitting the data based on the routing information, and transmits the data to a neighbor node based on the determination of the efficient method.

In accordance with another aspect of the present invention, methods, systems, and articles of manufacture consistent with the present invention describe a node within a network for dynamically routing data. The node includes a processor, a memory storage device coupled to the processor, and a communications interface coupled to the processor and at least one other system on the network. The processor can receive the data and an associated destination list at a transmitting node in the network. The processor can identify a destination for the data from the destination list. Also, the processor can reference a dynamic routing table for routing information for the destination and determine an efficient method of transmitting the data based on the routing information. The processor can transmit the data to a neighbor node based on the determination of the efficient method.

In accordance with yet another aspect of the present invention, methods, systems, and articles of manufacture consistent with the present invention describe a computer-readable medium that contains instructions for dynamically routing data within a network. When the instructions are executed, the data is received, along with an associated destination list, at a transmitting node in the network. The node identifies a destination for the data from the destination list. The node then references a dynamic routing table for routing information to the destination. Next, the node determines an efficient method of transmitting the data based on the routing information, and transmits the data to a neighbor node based on the determination of the efficient method.

Methods, systems, and articles of manufacture consistent with the present invention provide the ability to dynamically update routing data within a node of a network. The node determines the quality of a route from the node to a neighbor node as a quality factor. The node updates a dynamic routing table in the node with the quality factor for the connection to the neighbor node. Next, the node transmits the quality factor for the route to at least one other node in the network.

In accordance with another aspect of the present invention, methods, systems, and articles of manufacture consistent with the present invention describe a node within a network which dynamically updates its routing table. The node includes a processor, a memory storage device coupled to the processor, and a communications interface coupled to the processor and at least one other system on the network. The processor can determine the quality of a route from the node to a neighbor node as a quality factor. Also, the processor can update a dynamic routing table in the node with the quality factor for the connection to the neighbor node, and transmit the quality factor for the route to at least one other node in the network.

In accordance with yet another aspect of the present invention, methods, systems, and articles of manufacture consistent with the present invention describe a computer-readable medium that contains instructions for updating a routing table in a node. When the instructions are executed, the node determines the quality of a route from the node to a neighbor node as a quality factor. The node updates a dynamic routing table in the node with the quality factor for the connection to the neighbor node. Next, the node transmits the quality factor for the route to at least one other node in the network.

### BRIEF DESCRIPTION OF THE DRAWINGS

The accompanying drawings, which are incorporated in and constitute a part of this specification, illustrate an implementation of the invention. The drawings and the description serve to explain the advantages and principles of the invention. In the drawings,

FIG. 1A depicts an exemplary distributed network 1 suitable for practicing methods and implementing systems consistent with the present invention;

FIG. 1B depicts an exemplary network 100 suitable for practicing methods and implementing systems consistent with and embodiment of the present invention;

FIG. 2 depicts a typical destination list, consistent with an embodiment of the present invention, that is associated with the data;

FIG. 3 depicts a dynamic routing table 300 suitable for practicing methods and implementing systems consistent with and embodiment of the present invention;

FIG. 4 is a flow chart illustrating typical steps for determining the routing of data using a network of nodes consistent with an embodiment of the present invention;

FIG. 5, consisting of FIGS. 5A and 5B, illustrates node startup and discovery of neighbor nodes consistent with an embodiment of the present invention;

FIG. 6, consisting of FIGS. 6A and 6B, illustrates a dynamic routing table consisting of one hops consistent with an embodiment of the present invention;

FIG. 7 illustrates the network established by the sharing of routing information between two nodes consistent with an embodiment of the present invention;

FIG. 8, consisting of FIGS. 8A and 8B, illustrates dynamic routing tables for two nodes following the sharing of routing information consistent with an embodiment of the present invention;

FIG. 9 illustrates a flowchart of the dynamic routing table initialization process consistent with methods of the present invention; and

FIG. 10 illustrates the dynamic updating process within a node consistent with methods of the present invention.

### DESCRIPTION OF THE EMBODIMENTS

Reference will now be made in detail to an implementation consistent with the present invention as illustrated in the accompanying drawings. Wherever possible, the same reference numbers will be used throughout the drawings and the following description to refer to the same or like parts.

### Introduction

In general, methods and systems in an embodiment consistent with the present invention use a plurality of nodes that, when used with the dynamic update process and dynamic routing table, fundamentally changes how data is distributed across a network. No longer is data routed in a random fashion with the hope that eventually the data will reach its intended destination. In addition, data will not recycle through the system, wasting bandwidth by revisiting nodes multiple times on its way to its destination. Once the routing table is initialized, the table is dynamically updated by the dynamic updating process without the need for human intervention in order to optimize the routing of data. Also, data that is multicast to a wide range of destinations may be easily split up to optimize the path to each destination point.

### Network Architecture

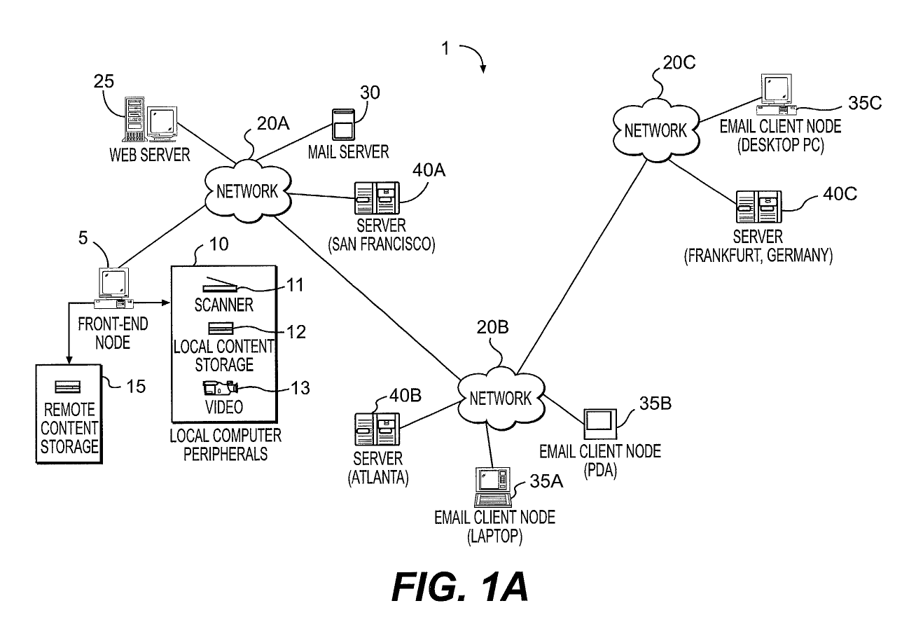

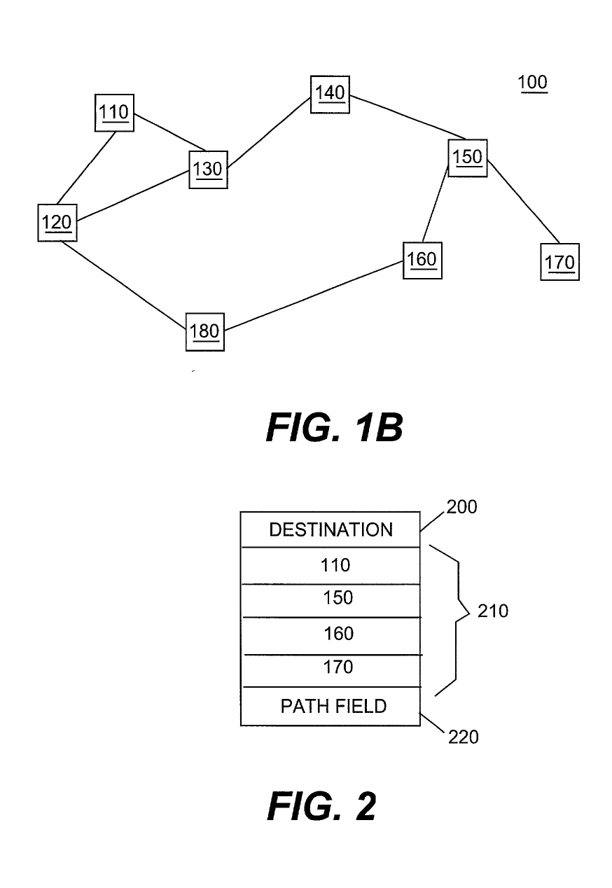

An embodiment of the present invention is described below where data is routed within a distributed network of interconnected nodes. This detailed embodiment shown in FIG. 1A will be followed by a more generalized embodiment shown in FIG. 1B for purposes of explaining the invention. Basically, FIG. 1A depicts an exemplary distributed network 1 in that it has processing, storage, and other functions which are handled by separate computing units (nodes) rather than by a single main computer. Furthermore, those skilled in the art will realize that such a network 1 may be implemented in a variety of forms (computing elements on a simple bus structure, a local area network (LAN), a wide area network (WAN), the global Internet, a broadband network with set-top communication devices, a wireless network of mobile communicating devices, etc.) that provides an intercommunication medium between its nodes.

Referring now to FIG. 1A, exemplary network 1 is labeled as separate network segments (referred to as subnetworks 20A, 20B, and 20C). While each of these subnetworks are interconnected and are actually part of network 1, it is merely convenient to label them separately into subnetworks to emphasize the different geographic locations of parts of network 1. Those skilled in the art will realize that each of these subnetworks can also be considered a network by itself and may also interconnect other nodes (not shown) or other networks (not shown). In the exemplary embodiment of FIG. 1A, subnetwork 20A interconnects a front-end node 5, a conventional web server 25, a conventional mail server 30, a dynamic content server 40A, each of which are physically located in the San Francisco, Calif. area. Other parts of network 1 include subnetwork 20B located in the Atlanta area (interconnecting another dynamic content server 40B and two email client nodes 35A and 35B to network 1) and subnetwork 20C located in the Frankfurt, Germany area. Subnetwork 20C interconnects yet another dynamic content server 40C and another email client node 35C to network 1.

Front-end node 5 is generally considered to be a network node having a processor, memory in which to run programs and create messages and a communications interface to connect to network 20A. In the exemplary embodiment, front-end node 5 is a conventional personal computer (running an operating system, such as the OS/2®, Windows® family, MacOS®, or Linux operating systems) with memory including a main memory of random access memory (RAM) and a local hard disk drive (not shown). Front-end node 5 further includes a conventional Ethernet network interface card for connecting to network 1 via a gateway (not shown) from a LAN (not shown) that is part of subnetwork 20A. Front-end node 5 may alternatively use a conventional modem (not shown) to connect to network 1 via a WAN (not shown) that is part of subnetwork 20A.

Those skilled in the art will appreciate that there are a many different types of communication devices that may communicate on a network as a front-end node. For example, a front-end node may be alternatively implemented as a mobile communications device having a microcontroller that accesses a small amount of RAM. The device would further include a radio transceiver with an antenna functioning as a communications interface that connects the device to a wireless network.

In the exemplary embodiment illustrated in FIG. 1A, front-end node 5 can be used to view web pages by sending an appropriately formatted request to web server 25. Front-end node 5 can also send conventional email by sending an appropriately formatted message from front-end node 5 to mail server 30, which will eventually route the message as data to its intended destination (such as an email client node on the network 1) when requested to do so.

According to an embodiment of the present invention, a user can distribute data from front-end node 5. Front-end node 5 is coupled to a variety of local computer peripherals 10 and remote content storage 15. The coupling may be accomplished via a simple bus connection to the peripheral, a network connection to the peripherals or through a separate interface, such as an USB connection, IEEE-488 bus connection or an RS-232 connection. The precise connection used with the local computer peripherals 10 will depend on the exact type of peripheral used.

The local computer peripherals 10 typically include a scanner 11, a local content storage device 12 and a video capture device 13. Local content storage device 12 and remote content storage 15 typically maintain multimedia content such as images, electronic presentations, word processing documents, pre-defined templates and other content useful for making a content-rich email message.

Similar to front-end node 5, each client node 35A-C is generally a network node (also called an access point) for receiving or forwarding data. Each client node 35A-C has a processor, memory in which to run programs and a communications interface (similar to that previously described) to connect to network 1. In the exemplary embodiment illustrated in FIG. 1A, client node 35A is a conventional personal computer (IBM-compatible) with a main memory of RAM (not shown), a local hard disk drive (not shown) and an Ethernet network interface card (not shown) for connecting to network 1 via subnetwork 20B. Alternatively, client node 35A may use a modem (not shown) to connect to network 1. In the exemplary embodiment, client node 35B is a network node implemented in a personal digital assistant (PDA) form factor while client node 35C is a network node implemented in a desktop personal computer form factor. Those skilled in the art will appreciate that any communication device (e.g., computer, PDA, mobile radio, cellular phone, set-top receiver, etc.) that can receive, forward or display data may be a client node. Furthermore, those skilled in the art will understand and recognize that any given node on network 1 may have the functionality of both a front-end node and a client node. Thus, a variety of implementations are possible for a client node.

Looking at servers 40A-40C, each is essentially a back-end server that manages content to be routed and distributed as data. The server stores any data that may need to be distributed to one or more client nodes.

In general terms, the server is a node having at least one processor, memory coupled to the processor for storing and broadcasting data, and a communications interface allowing the processor to be coupled to or in communication with other nodes on network 1. It is contemplated that the server may be implemented as a single processor, a personal computer, a minicomputer, a mainframe, a multiprocessing machine, a supercomputer, or a distributed sub-network of processing devices. In the exemplary embodiment, each of the dynamic content servers is a group of FullOn™ computers designed and distributed by VA Linux Systems of Sunnyvale, Calif. Each FullOn™ computer is a rack-mountable, dual-processor system with between 128 Mbytes and 512 Mbytes of RAM along with one or more hard drives capable of storing 8.4 Gbytes to 72.8 Gbytes of information. Each FullOn™ computer has two Pentium® III microprocessors from Intel Corporation and runs the Linux Operating System, which is considered to be result-compatible with conventional UNIX operating systems. Databases used on the servers are typically implemented using standard MySQL databases. Furthermore, each FullOn™ computer has an integrated 10/1 Mbit/sec Ethernet network interface for placing its processors in communication with other nodes on the network. Depending upon an anticipated amount of content storage space and an anticipated transactional load for the server, the size of the group of FullOn™0 computers can be adjusted and then configured to operate concurrently as a single server. Those skilled in the art will be familiar with configuring multiple computers to operate as a single server with farms of computers functioning as firewalls, database servers, proxy servers, and process load balancers. Further information on computers from VA Linux Systems, the Linux Operating System, and MySQL databases is available from a variety of commercially available printed and online sources.

Those skilled in the art will quickly recognize that a server may be implemented in any of a variety of server and network topologies using computer hardware and software from a variety of sources. Still other embodiments consistent with the present invention may implement a server using fault-tolerant integrated service control points within a wireless or landline advanced intelligent telecommunications network (AIN). Additionally, one skilled in the art will appreciate that while server may be implemented as a separate server node, it may also be incorporated into other network nodes, such as web server 25 or mail server 30. In the later situation, mail server node 30 would simply be programmed with the functionality described below associated with the back-end servers 40. Thus, it is apparent that network 1 and its associated nodes may be used to route data from one node (such as front end node) to another (such as client node 35C).

For purposes of clarity and simplification, FIG. 1B depicts a more generalized exemplary network 100 suitable for practicing methods and implementing systems that dynamically route data consistent with the present invention. This network 100 is distributed in that it has processing, storage, and other functions, which are handled by separate computing units, nodes, rather than by a single main computer. Further, those skilled in the art will appreciate that such a network 100 may be implemented in a variety of forms (computing elements on a simple bus structure, a local area network (LAN), a wide area network (WAN), the Internet, telecommunications infrastructure, a broadband network with set top communication devices, a wireless network of mobile computing devices, etc.) that provide an intercommunication medium between its nodes.

Each node on the network may be implemented as a single processor, a personal computer, a minicomputer, a mainframe, a multiprocessing machine, a supercomputer, or a distributed sub-network of processing devices. In the exemplary embodiment of the invention, each node comprises at least a processor, a communications interface, RAM memory, ROM memory, and a magnetic or optical storage device.

The exemplary network 100 is illustrated as having eight nodes (110, 120, 130, 140, 150, 160, 170, 180). Each node represents a single machine, multiple machines, or a subnetwork comprising a plurality of subnodes. In the exemplary network 100, all machines within a multiple machine node are interconnected on a local Ethernet. Note from FIG. 1B that the topology of the network is irrelevant. Each node on exemplary network 100 contains one or more adjacent, or neighbor, nodes. An adjacent, or neighbor, node is a node with a direct connection to a second node. For instance, node 8 has neighbor nodes 2 and 6. The concept of neighbor nodes is relevant for the discussion that follows later of the dynamic routing table.

Each node (110, 120, . . . 180) on exemplary network 100 has a unique address. While exemplary network 100 is a TCP/IP network, such that each node has a unique address #.#.#.# where # represents a number from 0 to 255 networking protocol can be used. For purposes of this description, we will refer to the nodes by their designations on FIG. 1B.

Embodiments of the present invention facilitates efficient transfer of data over a network from a single node to a plurality of nodes. Data traverses exemplary network 100 in packet form with a destination list associated with the data. FIG. 2 depicts a typical destination list, consistent with and embodiment of the present invention, that is associated with the data. The destination list 200 is a list of node addresses 210 to which the data is to be sent. In this example, the destination list is for nodes 110, 150, 160 and 170. In a TCP/IP networking environment, the list would contain the IP addresses of the nodes. Those skilled in the art will appreciate that other forms of addressing could be used in addition to IP addresses, such as domain name addressing, phone number addressing, or any other form of addressing that could be cross-referenced to the unique node name.

In addition, the last field of the destination list 200 is the path field 220. The path field 220 contains a list of nodes through which the data has previously traversed, along with quality information, known as a goodness factor, for each leg of the journey. Goodness factor will be explained in a later portion of this description. For example, data that has passed from node 170 to node 150 to node 140 to node 130 contains in its path field 220 the goodness factors: 170, G₁₇₀, 150, G₁₅₀, 140, G₁₄₀. The goodness factor G₁₇₀ is representative of the quality of the link from node 170 to node 150. The goodness factor G₁₅₀ is representative of the quality of the link from node 150 to node 140. The goodness factor G₁₄₀ is representative of the quality of the link from node 140 to node 130.

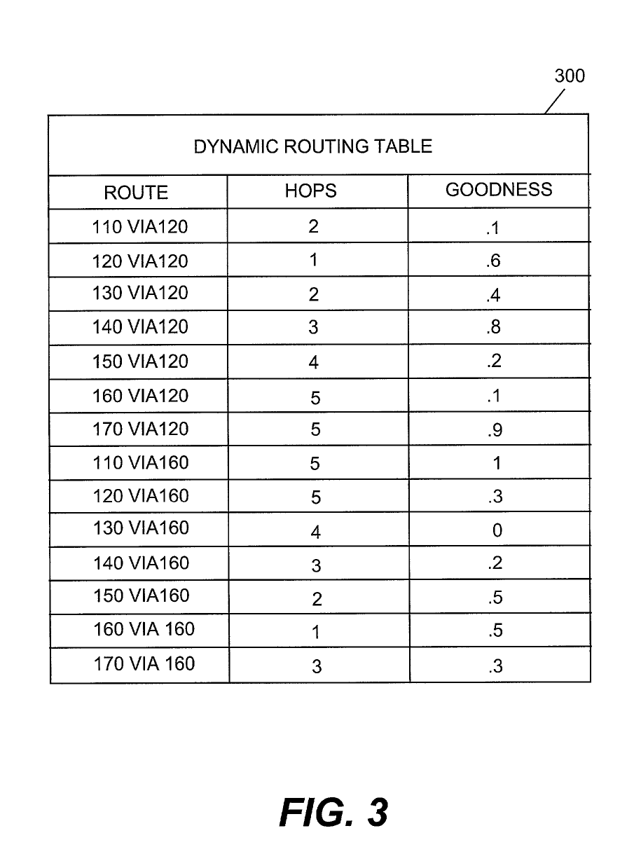

Within each node (110, 120, . . . , 180), there is a dynamic routing table 300. FIG. 3 depicts a dynamic routing table 300 suitable for practicing methods and implementing systems consistent with and embodiment of the present invention. The exemplary dynamic routing table 300 contains three columns: Route, Hops, and Goodness. The Route column has an entry for the route to every other node via every neighbor node. For instance, in the exemplary dynamic routing table 300 for node 8, there are route entries to every node from neighbor node 2 and route entries to every node from neighbor node 6. This makes for a total of 14 route entries. In any given network of n nodes, a given node x with y neighbor nodes will have a routing table of y*(n−1) entries. In addition, as traffic on the network 100 changes, entries in dynamic routing table 300 may be completely eliminated for any number of reasons, including, maintenance of a node, poor quality of a hop, or high cost of a node, etc.

For each route entry, the dynamic routing table 300 contains corresponding data for Hops and Goodness. Hops are the number of nodes that must be traversed for a data packet to travel from the current node to the destination node. For example, in the dynamic routing table 300 of node 8 of FIG. 3, for route “1 via 2”, the entry is 2. It takes two hops for data to travel from node 8 via node 2 to node 1. When routing data according to the present invention, a lower hops number is preferred because it indicate a more direct route to the destination.

The last column in the exemplary dynamic routing table 300 is the goodness factor labeled as Goodness. In the exemplary embodiment of the invention, a lower goodness factor is preferred (a goodness factor of 1 is the worst; a goodness factor of 0 is the best). The goodness factor represents any number of qualitative and quantitative feature of the corresponding route. In the exemplary embodiment of the invention, goodness factor is based on a decaying average of periodically sampled throughput for a node. Goodness factor can be based on other criteria. For instance, goodness factor can be representative of the ping time from the current node to the destination node via the route entry. Goodness factor can be representative of the relative costs to the network of utilizing route nodes or links. Goodness factor may be used by a network manager to encourage traffic via a certain route or away from a certain route. Those skilled in the art will realize the variety of factors that can be used in determining a Goodness factor. In addition, the Goodness factor need not be related to a single characteristic of a route, but may be a function of any number of factors. Goodness factors may include, but are not limited to: communications speed between nodes; packet loss on the links between nodes; general internet traffic on the links between nodes; and the status of the communications path between a series of nodes needed for ultimate delivery of the information.

### The Dynamic Routing Process

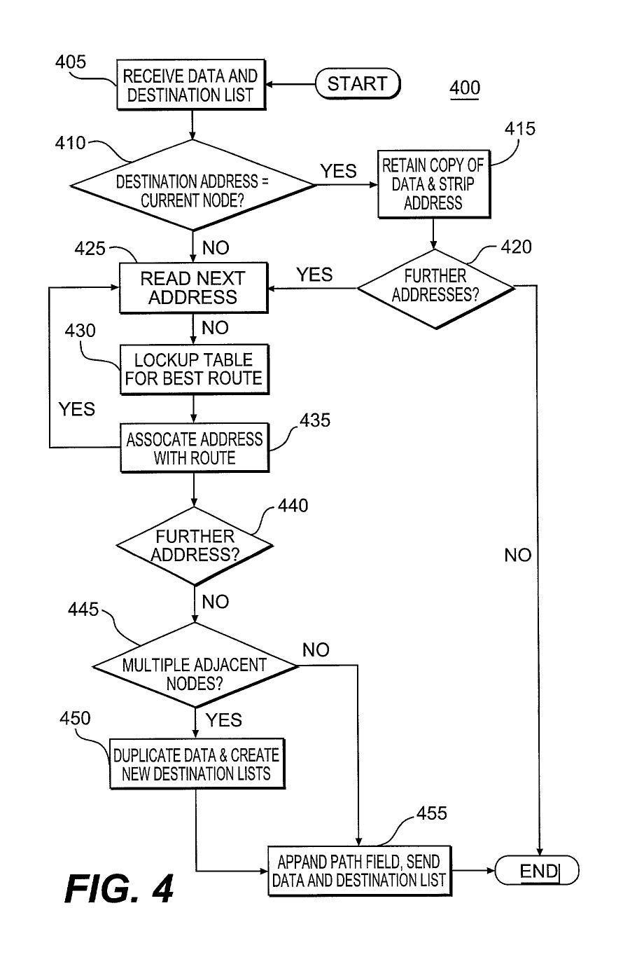

When data arrives at a node, along with its destination list, a routing process within the node analyzes the destination list to determine the best route to send the data. FIG. 4 is a flow chart illustrating typical steps for determining the routing of data using a network of nodes consistent with an embodiment of the present invention. Routing process 400 begins at step 405 where the node receives data and the associated destination list. The data and associated destination list may be received from an adjacent node or generated by the node itself. To facilitate explanation of the exemplary embodiment of the process of this invention, further discussion of routing process 400 will be in regard to node 180 with the destination list 200 of FIG. 2.

In step 410, routing process 400 examines the destination list to determine whether the current node, node 180, is a destination. In this example, the destination list contains the addresses of nodes 110, 150, 160, and 170; therefore, node 180 is not an intended destination for the data. Processing continues in step 425. If node 180 was a destination address, processing would have continued in step 415 where a copy of the data would be retained in the node, and the destination address 180 would be stripped from the destination list. At step 420, if further destination addresses were in the destination list, processing would continue in step 425.

Otherwise, processing stops.

At step 425, the next destination address is read from destination list 200. This destination address is then removed from the destination list 200.

At step 430, the dynamic routing table 300 is used to lookup the best route for the data based on the destination address. An algorithm calculates, for each possible route in the table, an efficiency factor. In the exemplary embodiment of the invention, the algorithm yields the result of the calculation constant, K, multiplied by the Hops, plus the goodness factor, or, Efficiency=K(Hops)+goodness factor. Lower efficiency values are preferred, so the lookup step 430 determines the lowest efficiency value for a route. In addition, the efficiency need not be calculated every time the routing process 400 executes; rather, the efficiency can be periodically calculated and stored as an additional value in dynamic routing table 300.

In destination list 200, the first destination address is 120. In the dynamic routing table 200, node 110 can be reached via node 120 and node 110 can be reached via node 160. Reaching node 110 via node 120 involves two hops with a goodness factor of 0.1. If K=0.5, the efficiency is 1.1, or 0.5(2)+0.1, for routing the data to node 110 via node 120. Reaching node 110 via node 160 involves five hops with a goodness factor of 1. If K=0.5, the efficiency is 3.5, or 0.5(5)+1, for routing the data to node 110 via node 160. Lookup step 430 determines the minimum value for efficiency to be 1.1 and chooses to send the data to node 110 via node 120.

At step 435, the destination address is associated with the best route. In this example, destination 110 from node 180 is designated to be routed to node 120. Node 120 would be associated with data transfer to node 110.

At step 440, routing process 400 checks whether further addresses are in the destination list 200. If further addresses are present, processing returns to step 425. Otherwise processing goes to step 445. In this example, destination addresses 150, 160 and 170 remain to be processed for routing, so control returns to step 425. These destinations will be routed via node 160.

At step 445, routing process 400 evaluates each of the designation addresses for each destination address. If multiple designation addresses are present, processing proceeds to step 450. Otherwise, processing proceeds to step 455.

At step 450, the data is duplicated appropriately with new destination lists associated with each one of the duplicated data. In this example, a first data set would exist with an associated destination list of 110, and a second data set would exist with an associated destination list of 150,160, and 170. Those skilled in the art will appreciate that multiple data sets do not actually have to be created; there can simply be multiple pointers to the same data set.

At step 455, the different data sets and associated destination lists are sent to the appropriate designated neighbor nodes. First, path data is appended to the path field 220. The path field would be the name of the current node and the goodness factor for the neighbor node to which the data is being sent. For example, for data being sent to neighbor node 120 from node 180, the value 0.6, which is the goodness factor for node 120 via node 120 in the dynamic routing table 300, is appended to the path field along with the address of the current node, 180. In this way, data about the health and quality of the network 100 is distributed through the network 100 within the data transfer.

In this example, the first data set with the destination list of 110 would be sent to neighbor node 120. The second data set with the destination list of 150,160, and 170 would be sent to neighbor node 160. At this point, routing process 400 is ended until new data is received at the node. As previously stated, each node runs its own routing process 400. Once the data arrives at the neighbor node, the routing process at the neighbor node continues the process of distributing the data.

### Initialization of the Dynamic Routing Tables

A dynamic routing table is constructed for each node of the network as the network is established. Upon startup of a node, the node forms connections to a number of neighbor nodes selected from a neighbor node table. The neighbor node table is typically pre-established for each node.

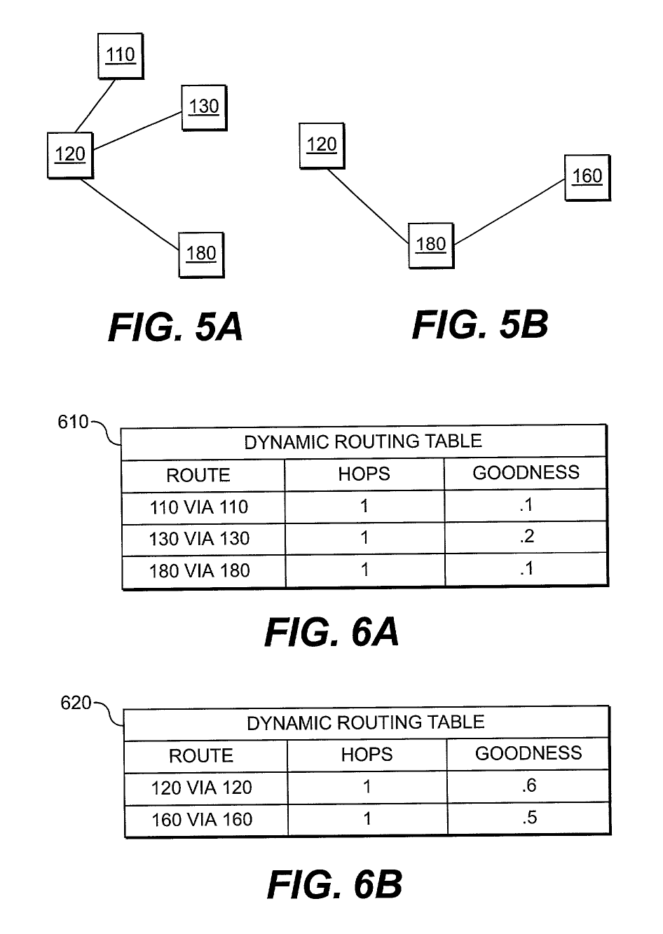

FIG. 5A illustrates the network established by node 120 to neighbor nodes 110,130 and 180 when node 120 is started up. Neighbor nodes 110,130 and 180 were selected from a neighbor node table accessed by node 120. The neighbor node table may reside locally at node 120 or remotely.

Once connected to selected neighbor nodes, a node creates an initial dynamic routing table, also known as a one-hop table because each node in the table is only one hop away. FIG. 6A illustrates the dynamic routing table 610 created by node 120 after connection with neighbor nodes. The dynamic routing table 610 contains the number of hops to each neighbor node. The goodness factor associated with each route, or neighbor, is determined initially by pinging the neighbor node. Those skilled in the art will appreciate that the goodness factor can also be randomly determined or preset.

As each node is started up, it goes through a similar process. FIG. 5B illustrates the network established by node 180 to neighbor nodes 120 and 160. FIG. 6B illustrates the dynamic routing table 620 created by node 180 after connection with neighbor nodes.

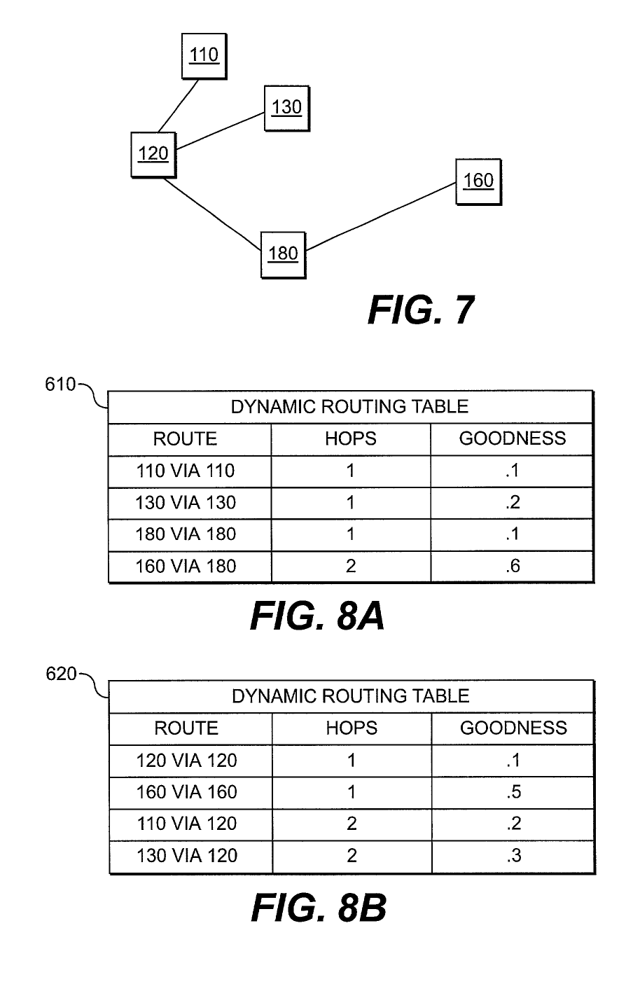

As nodes become aware of each other, and each other's relative networks, the nodes share routing information with each other. FIG. 7 illustrates the network established by the sharing of routing information between node 120 and node 180 consistent with an embodiment of the present invention. Periodically the nodes query their neighbor nodes for routing table information, which they can share. This new routing information is added to the dynamic routing table of the querying node.

FIGS. 8A and 8B illustrate the dynamic routing tables 610 and 620 for nodes 120 and 180 respectively. When node 120 queries node 180, node 180 responds with the routing information: 160 via 160, one hop, 0.5 goodness factor. Node 120 adds this information to dynamic routing table 610 by forming the 160 via 180 entry. The 160 via 180 entry adds the 180 via 180 hop count to the 160 via 160 hop count and places a 2 in the Hops entry. Similarly, the 160 via 180 entry adds the 180 via 180 goodness factor to the 160 via 160 goodness factor and places a 0.6 in the goodness factor entry. In this manner, the dynamic routing table 610 is constructed for node 120.

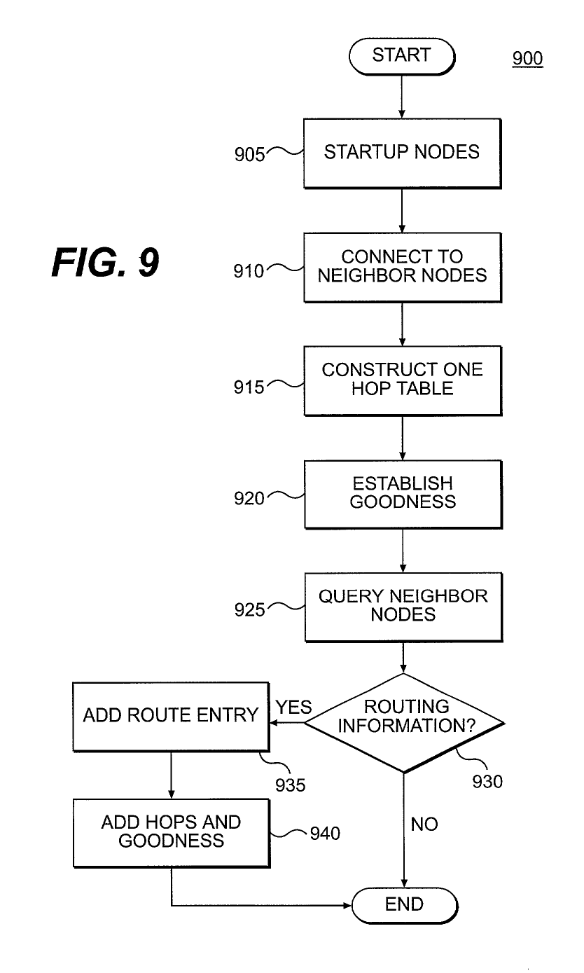

FIG. 9 illustrates a flowchart of the dynamic routing table initialization process consistent with an exemplary method of the present invention. The initialization process begins at step 905 when the node is first started up. At step 910, the node connects to neighbor nodes based on a neighbor node table. At step 915, the node constructs its initial dynamic routing table, or one-hop table. The dynamic routing table is constructed with a list of routes and an entry of one for Hops. At step 920, goodness factors are established. As described above, the goodness factor entry is based on a ping value or some other predetermined, calculated, or basic value.

At step 925, following establishment of the dynamic routing table, neighbors listed in the dynamic routing table are queried for routing information. At 930, if dynamic routing tables are not found, the process ends. Otherwise, processing continues at step 935.

At step 935, routing information is received from the neighbor nodes and added to the dynamic routing table. For each new node discovered, a routing entry is added to the table. For instance, if node x queries neighbor node y for routing information and routing information for node z is returned, node x creates an entry for z via y. At step 940, the hops and goodness factor fields are added to the routing information. The hops field is entered by adding one to the hops returned from node y. The goodness factor is entered by adding the goodness returned from node y to the goodness factor in the querying node's entry for y via y. This completes the initialization process 900.

### The Dynamic Updating Process

Following table initialization, the dynamic updating process within each node monitors data traffic flow around the network by examining the path field 200 of the destination list associated with data packets as they are transmitted around the network. As links between nodes degrade, this fact will be reflected in the goodness values for routes in the dynamic routing table; therefore, this path will become less attractive to the routing process 400. As the dynamic updating process notices increased traffic between two nodes that are not directly connected, it will request that those nodes form a direct connection.

In an embodiment of the dynamic updating process, each node will periodically ping its neighbor nodes to update the goodness values for route entries of neighbor nodes in its dynamic routing table. These updated goodness values will alter the calculation used by the routing process 400 in choosing data paths for data transfers. The goodness values are transmitted throughout the rest of the network through entries in the path field 220 of destination lists 200 associated with data. Periodically, a node examines the path field of a destination list and updates its goodness values within its dynamic routing table accordingly. As stated earlier, each path field contains the goodness values for each node-to-node path traversed. Therefore, a poor goodness factor for a remote node will be transmitted through the network resulting in updating of dynamic routing tables throughout the network. Data will not become blocked in front of a poor node or connection because an originating node will not send data through that path.

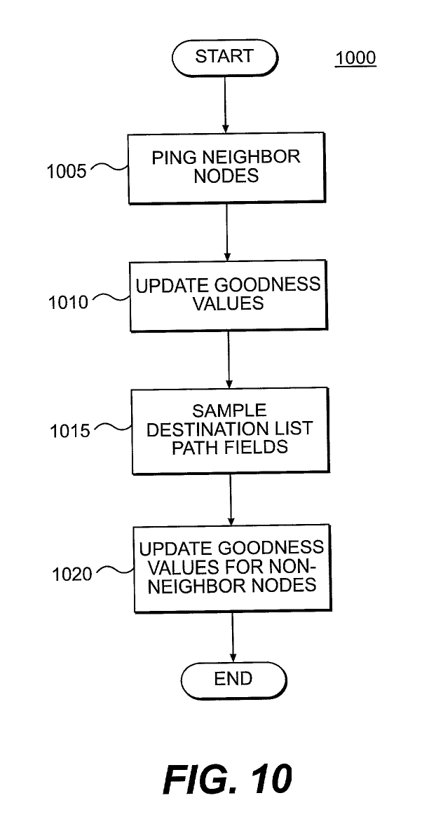

FIG. 10 illustrates an embodiment of the dynamic updating process within a node consistent with methods of the present invention. At step 1005, the dynamic updating process 1000 in a node pings each of its neighbor nodes to determine the quality of the connection. At step 1010, the goodness values are updated for each of the neighbor nodes pinged. Using node 120 of FIG. 1B as an example, nodes 110, 130 and 180 are pinged and the goodness values for 110 via 110, 130 via 130, and 180 via 180, respectively, are updated.

At step 1015, the dynamic updating process 1000 samples the path field 220 for goodness values from through the network. For example, a data packet arriving at node 120 that has traveled from node 150 may have (130, 0.1, 140, 0.2, 150, 0.3) in its path field 220. At step 1020, the goodness value for route entry 150 via 130 is 0.1+0.2+0.3, or 0.6, which is entered in the dynamic routing table of node 120. If the goodness from 150 to 140 were to rise because of a poor connection, that would be reflected in the goodness value of 150 via 130 in the dynamic routing table of node 120. Therefore, node 120 would resist using the 150 via 130 route.

The foregoing description of embodiments of the invention has been presented for purposes of illustration and description. It is not exhaustive and does not limit the invention to the precise form disclosed. Modifications and variations are possible in light of the above teachings or may be acquired from practicing of the invention. For example, the described implementation includes a particular network configuration but the present invention may be implemented in a variety of data communication network environments using software, hardware or a combination of hardware and software to provide the processing functions.

Those skilled in the art will appreciate that all or part of systems and methods consistent with the present invention may be stored on or read from other computer-readable media, such as secondary storage devices, like hard disks, floppy disks, and CD-ROM; a carrier wave received from the Internet; or other forms of computer-readable memory, such as read-only memory (ROM) or random-access memory (RAM).

Furthermore, one skilled in the art will also realize that the processes illustrated in FIGS. 4, 9 and 10 may be implemented in a variety of ways and include multiple other modules, programs, applications, scripts, processes, threads, or code sections that all functionally interrelate with each other to accomplish the individual tasks described above for each module, script, and daemon. For example, it is contemplated that these programs modules may be implemented using commercially available software tools, using custom object-oriented code written in the C++programming language, using applets written in the Java programming language, or may be implemented as with discrete electrical components or as one or more hardwired application specific integrated circuits (ASIC) custom designed just for this purpose.

Therefore, the scope of the invention is defined strictly by the claims and their equivalents.

what is claimed is:

1. A method of dynamically routing data within a network, comprising the steps of:
receiving the data and an associated destination list at a transmitting node in the network;
identifying a destination for the data from the destination list;
referencing a dynamic routing table for routing information for the destination;
determining an efficient method of transmitting the data based on the routing information; and
transmitting the data to a neighbor node based on the determination of the method.

2. The method of claim 1, wherein the step of identifying a destination further comprises reading a destination address from the destination list.

3. The method of claim 2, wherein the step of reading a destination address from the destination list further comprises removing the destination address from the destination list.

4. The method of claim 1, wherein the step of referencing a dynamic routing table further comprises looking up a possible route in the dynamic routing table.

5. The method of claim 4, wherein the step of looking up the possible route in the dynamic routing table further comprises reading a value associated with a number of hops for the possible route.

6. The method of claim 4, wherein the step of looking up the possible route in the dynamic routing table further comprises reading a value associated with the goodness factor for the possible route.

7. The method of claim 5, wherein the step of determining the most efficient method of transmitting the data further comprises performing a calculation on the routing information.

8. The method of claim 7, wherein the step of performing the calculation on the routing information further comprises choosing a route based on the calculation.

9. The method of claim 1, wherein the step of transmitting the data further comprises the step of appending path field information to the destination list associated with the data.

10. The method of claim 9, wherein the step of appending path field information to the data further comprises appending the address of the transmitting node and the goodness factor of the neighbor node to the destination list associated with the data.

11. The method of claim 1, further comprising the step of updating the dynamic routing table based on path field information of the destination list associated with the data.

12. The method of claim 1 further comprising the step of repeating the identifying, referencing, determining, and transmitting steps for each destination with the destination list.

13. The method of claim 1, wherein the transmitting step further comprises appending a new destination list to the data prior to transmittal.

14. The method of claim 12, wherein the transmitting step further comprises appending a new destination list to the data prior to transmittal.

15. A node within a network for dynamically routing data, comprising:
a processor;
a memory storage device coupled to the processor;
a communications interface coupled to the processor and at least one other system on the network; and
the processor being operative to
receive the data and an associated destination list at the node in the network,
identify a destination for the data from the destination list,
reference a dynamic routing table for routing information for the destination node,
determine an efficient method of transmitting the data based on the routing information, and
cause the data to be transmitted through the communications interface based on the determination of the efficient method.

16. The system of claim 15, wherein the processor is further operative to read a destination address from the destination list.

17. The system of claim 16, wherein the processor is further operative to remove the destination address from the destination list.

18. The system of claim 15, wherein the processor is further operative to look up a possible route in the dynamic routing table.

19. The system of claim 18, wherein the processor is further operative to read a value associated with the number of hops for the possible route.

20. The system of claim 18, wherein the processor is further operative to read a value associated with a goodness factor for the possible route.

21. The system of claim 19, wherein the processor is further operative to perform a calculation on the routing information.

22. The system of claim 21, wherein the processor is further operative to choose a route based on the calculation.

23. The system of claim 15, wherein the processor is further operative to append path field information to the data.

24. The system of claim 22, wherein the processor is further operative to append the address of the transmitting node and a goodness factor of the neighbor node.

25. The system of claim 23, wherein the processor is further operative to update the dynamic routing table based on path field information of the destination list associated with the data.

26. The system of claim 15, wherein the processor is further operative to append a new destination list to the data prior to transmittal.

27. A computer-readable medium containing instructions for dynamically routing data across a network, the instructions comprising the steps of:
receiving the data and an associated destination list at a transmitting node in the network;
identifying a destination for the data from the destination list;
referencing a dynamic routing table for routing information for the destination;
determining an efficient method of transmitting the data based on the routing information; and
transmitting the data to a neighbor node based on the determination of the efficient method.

28. The computer-readable medium of claim 26, wherein the step of identifying a destination further comprises reading a destination address from the destination list.

29. The computer-readable medium of claim 27, wherein the step of reading a destination address from the destination list further comprises removing the destination address from the destination list.

30. The computer-readable medium of claim 26, wherein the step of referencing a dynamic routing table further comprises looking up a possible route in the dynamic routing table.

31. The computer-readable medium of claim 29, wherein the step of looking up the possible route in the dynamic routing table further comprises reading a value associated with a number of hops for the possible route.

32. The computer-readable medium of claim 29, wherein the step of looking up the possible route in the dynamic routing table further comprises reading a value associated with a goodness factor for the possible route.

33. The computer-readable medium of claim 30, wherein the step of determining the most efficient method of transmitting the data further comprises performing a calculation on the routing information.

34. The computer-readable medium of claim 32, wherein the step of performing a calculation on the routing information further comprises choosing a route based on the calculation.

35. The computer-readable medium of claim 26, wherein the step of transmitting the data further comprises the step of appending path field information to the data.

36. The computer-readable medium of claim 34, wherein the step of appending path field information to the data further comprises appending the address of the transmitting node and a goodness factor of the neighbor node.

37. The computer-readable medium of claim 35, further comprising the step of updating the dynamic routing table based on the path field information of the destination list associated with the data.

38. The computer-readable medium of claim 26 further comprising the step of repeating the identifying, referencing, determining, and transmitting steps for each destination with the destination list.

39. The computer-readable medium of claim 26, wherein the transmitting step further comprises appending a new destination list to the data prior to transmittal.

40. The computer-readable medium of claim 37, wherein the transmitting step further comprises appending a new destination list to the data prior to transmittal.

41. A method of dynamically updating routing information within a node of a network, comprising the steps of:
determining the quality of a route from the node to a neighbor node as a quality factor;
updating a dynamic routing table in the node with the quality factor for the connection to the neighbor node; and
transmitting the quality factor for the route to at least one other node in the network.

42. The method of claim 40, wherein the quality factor of the route is a goodness factor.

43. The method of claim 40, wherein the step of transmitting the quality factor further comprises the steps of:
associating the quality factor with the route; and
transmitting the quality factor and route with data to at least one other node in the network.

44. The method of claim 42, wherein the quality factor is the goodness factor.

45. The method of claim 42, wherein the step of transmitting the quality factor and route further comprises the step of:
appending the quality factor and route to a path field of a destination list associated with the data.

46. The method of claim 42, wherein the step of transmitting the quality factor and route is further comprised of transmitting the quality factor and route to the neighbor node.

47. The method of claim 40, further comprising the steps of:
receiving a second quality factor for a second route from a second node in the network; and
updating the dynamic routing table in the node with the second quality factor for the second route.

48. A node within a network, comprising:
a processor;
a memory storage device coupled to the processor;
a communications interface coupled to the processor and at least one other node on the network; and
the processor being operative to
determine the quality of a route from the node to a neighbor node as a quality factor,
update a dynamic routing table in the node with the quality factor for the connection to the neighbor node, and
transmit the quality factor for the route to at least one other node in the network.

49. The system of claim 47, wherein the quality factor of the route is a goodness factor.

50. The system of claim 48, wherein the processor is further operative to
associating the quality factor with the route, and
transmitting the quality factor and route with data to at least one other node in the network.

51. The system of claim 49, wherein the quality factor is the goodness factor.

52. The system of claim 49, wherein the processor is further operative to append the quality factor and route to a path field of a destination list associated with the data.

53. The system of claim 49, wherein the processor is further operative to transmit the quality factor and route to the neighbor node.

54. The system of claim 47, the processor is further operative to
receive a second quality factor for a second route from a second node in the network, and
update the dynamic routing table in the node with the second quality factor for the second route.

55. A computer-readable medium containing instructions for dynamically updating a routing table of a node, the instructions comprising the steps of:
determining the quality of a route from the node to a neighbor node as a quality factor;
updating a dynamic routing table in the node with the quality factor for the connection to the neighbor node; and
transmitting the quality factor for the route to at least one other node in the network.

56. The computer-readable medium of claim 54, wherein the quality factor of the route is a goodness factor.

57. The computer-readable medium of claim 54, wherein the step of transmitting the quality factor further comprises the steps of:
associating the quality factor with the route; and
transmitting the quality factor and route with data to at least one other node in the network.

58. The computer-readable medium of claim 56, wherein the quality factor is the goodness factor.

59. The computer-readable medium of claim 56, wherein the step of transmitting the quality factor and route further comprises the step of:
appending the quality factor and route to a path field of a destination list associated with the data.

60. The computer-readable medium of claim 56, wherein the step of transmitting the quality factor and route is further comprised of transmitting the quality factor and route to the neighbor node.

61. The computer-readable medium of claim 54, further comprising the steps of:
receiving a second quality factor for a second route from a second node in the network; and
updating the dynamic routing table in the node with the second quality factor for the second route.
